(19) United States
(12) Patent Application Publication
(10) Pub. No.: US 2004/0148210 A1
(43) Pub. Date: Jul. 29, 2004

(54) Preference and attribute profiler

(76) Inventors: Paul Barrett, Pukekohe (NZ); Phil Jamieson, Auckland (NZ); Baruch Ter Wal, Auckland (NZ)

Correspondence Address: JACOBSON HOLMAN PLLC, 400 SEVENTH STREET N.W., SUITE 600, WASHINGTON, DC, 20004, US

(21) Appl. No.: 10/683,113

(22) Filed: Oct. 14, 2003

Related U.S. Application Data
(63) Continuation of application No. PCT/NZ02/00028, filed on Mar. 11, 2002.

(30) Foreign Application Priority Data
Apr. 12, 2001 (NZ) 511143
Feb. 12, 2002 (NZ) 517136

(51) Int. Cl. G06F 17/60

(52) U.S. Cl. 705/7; 705/10

(57) ABSTRACT

A system that allows a respondent to indicate a preference for one or more psychological or other relevant attribute, placing said attribute into an area defined by one or more static variable axes. The response area and movement of attributes within that area, relative to one or more static variable axes, are defined on a computer-screen with movement of attributes enabled using a computer-mouse or other computer-based technology for moving objects displayed on a display unit such as a standard video monitor or liquid crystal display. Direct attribute movement and placement against a variable axis allows feedback, such that the user can reposition earlier preferences relative to later attributes.

### FIELD OF THE INVENTION

The present invention relates to a method of interrogating individuals, particularly but not solely, relating to interrogation for the purposes of response feature-analysis.

### BACKGROUND TO THE INVENTION

Responses, answers, or feedback from an individual can be elucidated in one of two broad categories, Verbal and Non Verbal. Verbal in this context, means the use of a language or numbered rating categories (either spoken or written) as a means of responding to probes which may themselves be graphical objects, text items, or spoken questions. As can be seen from FIG. 1, when relying on the use of language for responding, four main techniques of assessment exist.

Questionnaires/Interviews 1 can request responses in a forced choice format. For example, the individual might be requested to choose the statement that is the most descriptive of themselves and the least descriptive of themselves from a group of four statements that describe different features of behaviour, or express four different kinds of preference. The individual is “forced” to choose between these four items. Alternatively, all that is required from an individual may be a single rating response. That is, the individual is required to rate single statements as True/False, or Agree/Disagree, or from Strongly Dislike through to Strongly Prefer in five steps (using a number category rating scale of say one to five). Finally, responses may be elicited by not providing any form of fixed response, but rather, requiring the individual to respond with whatever comments or answers they would like to make. An example here might be a market research question that asks respondents “Why do you like product X?” with just a box for the respondent to provide a written response, or an interviewer who transcribes the respondents verbal responses for later coding. Focus groups especially make significant use of free responses from individuals, and code for content and other attributes at a later date.

Repertory Grid/Scaling Methodologies 2 require that an individual make a series of judgements about stimuli (products, preferences, people etc.) in order that an investigator can determine whether the judgements or responses are the result of just a few “constructs” being used by an individual, or are perhaps indicative of more complex decision processes. An individual can be asked to rate objects in comparison with one another, perhaps in a series of triads (which object do you most prefer out of these three, or rank your preference for these three objects), forming a “judgement matrix”. Alternatively, a rating matrix may be generated whereby an individual is required to rate a series of objects, on a series of descriptive attributes such as “boring”, “useful”, “physical”, “fun”, using a five point rating scale that varies between one=not at all through to five=all the time. The matrix of judgements/ratings is then analysed in order to explore the evidence that perhaps just one or two dimensions of “judgement” or “preference” are accounting for all the various judgements or ratings made.

The first form of Projective Tests 3, used in the main by clinical and counselling psychologists, require an individual either to provide free verbal responses or narratives to graphic pictures or objects shown to them, or, to draw pictures themselves that will be interpreted by a clinician. This latter use is best described as a “nonverbal” response and will be discussed as one of the Non Verbal forms of response elicitation. A famous example of the kind of “verbal” response projective test is the Rorschach Inkblot test, where an individual is shown pictures of inkblots, and is asked to verbalise as to what they think they think the shape looks like.

Again referring to FIG. 1, there are four forms of Non Verbal assessment, discussed below.

Psychophysiological Indices 4 are where a response from an individual is acquired from some feature of their physiology. For example, in integrity or honesty testing, the polygraph is used to record an individual's heart rate, respiration rate, skin conductance, and skin temperature in response to various verbal and non verbal stimuli. In addition, brain responses might be used within a clinical setting.

Behaviour Response Counting 5 is used where the frequency of certain kinds of behaviours is the variable under interest. This can range from say criminal offence occurrences of individuals as used in corrections/forensic risk research, through to the number of products purchased over a particular period of time (as in market research). Response counts may also be used by video raters of individuals behaving “normally” within specific video surveillance/observation environments.

Behaviour Response Ratings 6, as well as the previous “observational” methodology, might also be considered relevant to rate the behaviour of individuals on certain attribute scales. For example, not only is the rate of occurrence of a particular event logged, but so may be a rating of the amount of aggression or verbalisation shown during each event.

The second form of Projective Tests 7 require that an individual place or draw objects in some defined area, on the basis that features of how they are placed or drawn can yield interpretations that assist a clinician in determining certain observations about an individual's state of mind. For example, the House Tree Person test requires that an individual draw a house, a tree, and a person. How they do this is entirely at their discretion. However, a psychodynamic clinician might claim to make certain statements about an individual based upon how the three “objects” are drawn, and in what relation to one another they stand.

### SUMMARY OF THE INVENTION

The object of the present invention is to provide a method of interrogating individuals which goes some way to overcoming any disadvantages in the prior art, or which will at least provide the public with a useful choice.

In a first aspect the present invention consists in a method of interrogating at least one subject, comprising the steps of:

a) providing a response area for positioning a plurality of attributes relative to at least one axis defining the area;

b) receiving input from said subject providing axis-coordinate(s) within said response area for a first attribute; and

c) receiving input from said subject providing coordinate(s) within said response area for at least one further attribute.

Preferably said method further comprises the steps of receiving a plurality of coordinate(s) for a plurality of further attributes.

Preferably each said step involving receiving coordinate(s) also includes an ensuing sub step of displaying said response area with each of said plurality of attributes positioned according to said received coordinate(s) and optionally receiving updated coordinate(s) for each of said plurality of attributes.

Preferably the coordinate(s) of any of said further attributes, may be constrained by and/or may in turn effect, the coordinate(s) of any previous attribute.

Preferably said method further comprises an initial step of providing at least one linear response scale, each said scale for positioning an attribute relative to a single variable.

In a second aspect the present invention consists in a software program comprising:

a graphical interface for positioning a plurality of attributes relative to at least one or more coordinate axes,

input means receiving positioning information for each of said plurality of attributes, and

control means constraining the relative positioning and repositioning of each attribute relative to the remaining attributes within said graphical interface.

In a third aspect the present invention consists in a method of conducting a psychometric testing of at least one subject, comprising the steps of:

1) providing a response area for positioning a plurality of characteristics relative to at least one variable axis; and

2) receiving rating input from said subject providing coordinate(s) within said response area for a first characteristic; and

3) receiving rating input from said subject providing coordinate(s) within said response area for at least one further characteristic.

Preferably said method is implemented in a software program, wherein when said program is executed in a computer, said response area is graphically displayed by said computer.

Preferably said method further comprises the steps of receiving a plurality of coordinate(s) for a plurality of further characteristics.

Preferably each said step involving receiving coordinate(s) also includes a ensuing sub step of displaying said matrix with each of said plurality of characteristics positioned according to said received coordinate(s) and optionally receiving updated coordinate(s) for each of said plurality of characteristics.

Preferably the coordinate(s) of any of said further characteristics, may be constrained by and/or may in turn effect, the coordinate(s) of any previous characteristic.

Preferably said method further comprises an initial step of providing at least two linear response scales, each said scale for positioning a characteristic relative to a single rating.

Preferably said method further comprises the step of assigning, for a plurality of objectives predetermined optimum values for the coordinate(s) for each of said plurality of characteristics, whereby the subject is given a measure of suitability for each objective based on the fit of the subjects characteristics compared to the respective optimum for that objective.

In a fourth aspect the present invention consists in a method of conducting a market survey of at least one individual, comprising the steps of:

i) providing a response area for positioning a plurality of attributes relative to at least two coordinate(s);

ii) receiving input from said subject providing coordinate(s) within said response area for a first attribute; and

iii) receiving input from said subject providing coordinate(s) within said response area for at least one further attribute.

Preferably said method is implemented in software program, wherein when said program is executed in a computer, said response area is graphically displayed by said computer.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

The invention consists in the foregoing and also envisages constructions of which the following gives examples.

### BRIEF DESCRIPTION OF THE DRAWINGS

One preferred form of the present invention will now be described with reference to the accompanying drawings in which;

FIG. 1 is a schematic showing the various forms of psychological testing methods,

FIG. 2 is a 1D example of the present invention for conducting market research

FIG. 3 is a 2D example of the present invention for conducting market research

FIG. 4 is a 3D example of the present invention for conducting market research,

FIG. 5 shows the FIG. 4 graph rotated,

FIG. 6 shows in the FIG. 4 graph rotated further,

FIG. 7 is an illustration of the 2D response area according to the preferred embodiment of the present invention,

FIG. 8 is an illustration of positioning of an input response attribute,

FIG. 9 shows the initial positioning of the opposite attribute in FIG. 8,

FIG. 10 shows the constraints on movement in relation to the opposite attribute,

FIG. 11 is an illustration of a completed response area,

FIG. 12A shows an alternative input screen in its initial state,

FIG. 12B shows the alternative input screen of FIG. 12A after user input,

FIG. 13 shows a response area screen from the example in FIG. 12B,

FIG. 14 is a 1D prior art questionnaire,

FIG. 15 is a 2D prior art questionnaire,

FIG. 16 is a 3D prior art questionnaire,

FIG. 17 is a 1D example of the present invention for conducting “dating” work,

FIG. 18 is a 1D example of the present invention for conducting “dating” work with a single attribute initially positioned,

FIG. 19 is a 1D example of the present invention for conducting “dating” work with a single attribute finally positioned,

FIG. 20 is a 1D example of the present invention for conducting “dating” work with several attributes finally positioned, and

FIG. 21 is a block diagram of the hardware requirements according to the preferred embodiment of the present invention.

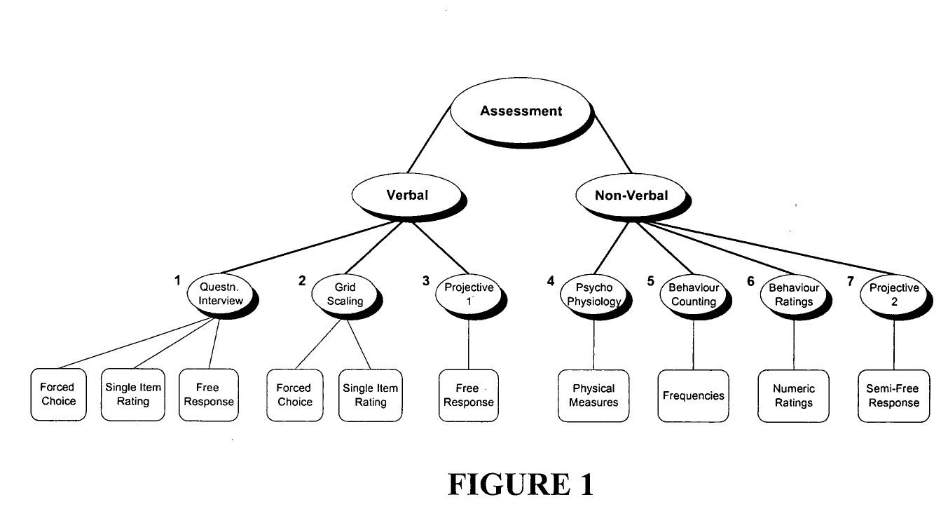

### DETAILED DESCRIPTION OF THE PREFERRED EMBODIMENTS

The key feature of the invention is that it allows a respondent to indicate a preference for one or more psychological or other relevant attribute, placing said attribute into an area defined by one or more static variable axes. The response area and movement of attributes within that area, relative to one or more static variable axes, are defined on a computer-screen with movement of attributes enabled using a computer-mouse or other computer-based technology for moving objects displayed on a display unit such as a standard video monitor or liquid crystal display. It is this direct attribute movement and placement against a variable axis which sets the p resent invention apart from other methods of assessment.

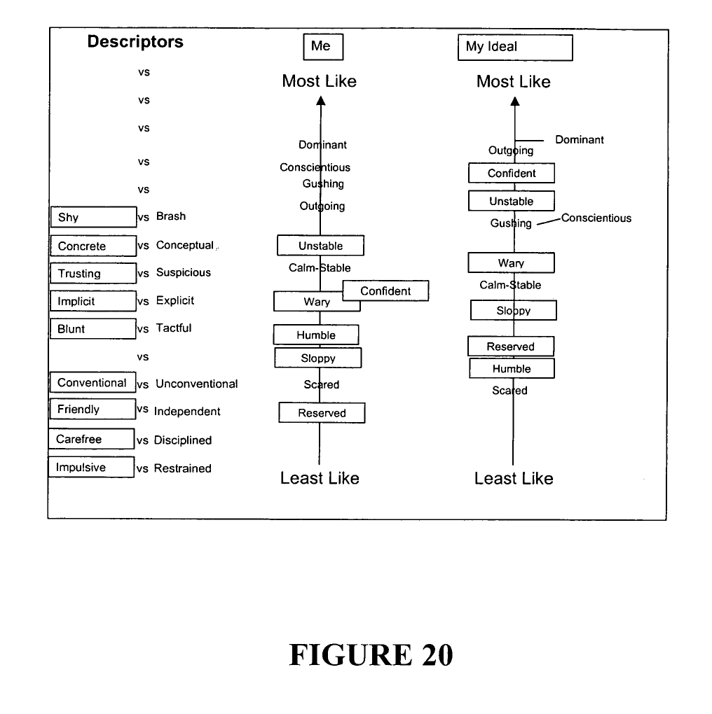

Referring to FIG. 21 the core hardware components of the present invention are shown.

The user interfaces with the system primarily with display 504, and user input 502. As already mentioned the display 504 may take any one of a number of forms such as a standard video monitor, liquid crystal display or other graphical interface. The display 504 may also include a touch screen such that user input 502 is integrated. The user input 502 may include a mouse, keyboard, joystick or other interfaces which allow the user to manipulate the location of items on the display 504.

The display 504 and user input 502 are connected to a data processor 500 which receives the input data and outputs to the display according to the present invention. The data processor 500 may be a remote server, a micro controller or the Central Processing Unit of a computer (such a computer might also include the display 504 and user input 502). Storage device 506 eg: RAM/hard disk or other media is connected to the data processor 500 to store both instructions regarding operation of the data processor 500, as well as received input from the user. The data processor 500 may also be connected through data communications 508 to further user interfaces further data processors (either operating on the same task or some other task), and/or further storage devices. It will be appreciated the present invention could be delivered in a standalone configuration, through the Internet, using a server/client configuration or any other communication medium.

The present invention can utilise both verbal and non verbal (graphical) stimuli, it is a generic technology into which a wide variety of stimuli can be utilised as “meaning laden” attributes. These stimuli are required to be positioned into a 1, 2, or 3 dimensional space, according to some rule or rules given to an individual as part of an assessment task. Unlike other techniques for acquiring ratings from individuals, the present invention allows the user to manipulate attributes directly against a reference variable axis. That is, instead of asking an individual to move a pointer along a scale for every attribute to be assessed, we ask the user to position one or more attributes against one or more measurement variable scales/axes. This innovation has clear advantages over “pointer-based” one-at-a-time attribute assessment systems.

Although the actions involved in the assessment can be implemented without using a computer, this is considered sub optimal from a user perspective, and hence the preferred embodiment requires using a computer, display screen, mouse, and keyboard to present stimuli and acquire responses. However, one skilled in the art will appreciate a number forms of stimulus presentation and response acquisition are equally appropriate for use with the present invention.

The present invention in a number of the embodiments detailed later, can be implemented in 1, 2, or 3 graphic dimensions (a line, a rectangle, a cube, a circle, or a sphere). Regardless of the dimensional view, the essential feature of the present invention is that an individual is required to place an object or word into a meaningfully described graphical region. The purpose of doing this is to make some quantitative or order-relation statement about the positioned item that in turn can be related to some meaningful criterion or construct.

With respect to the “placing of objects or words into the meaningfully described graphical region”, this can be achieved either directly or indirectly. The direct method is to literally “pick up/select” an object or word using a mouse and place it into a defined on screen region. The indirect method uses some form of an initial “coordinate” acquisition methodology to first acquire spatial coordinates for an object or word, thus permitting the placing of the object or word in graphical space at the acquired coordinates. Given the coordinates are meaningful quantitative values, the manner in which they acquired corresponds to a scaling procedure in 1, 2, or 3 dimensions, taken one dimension at a time.

A One Dimensional Example

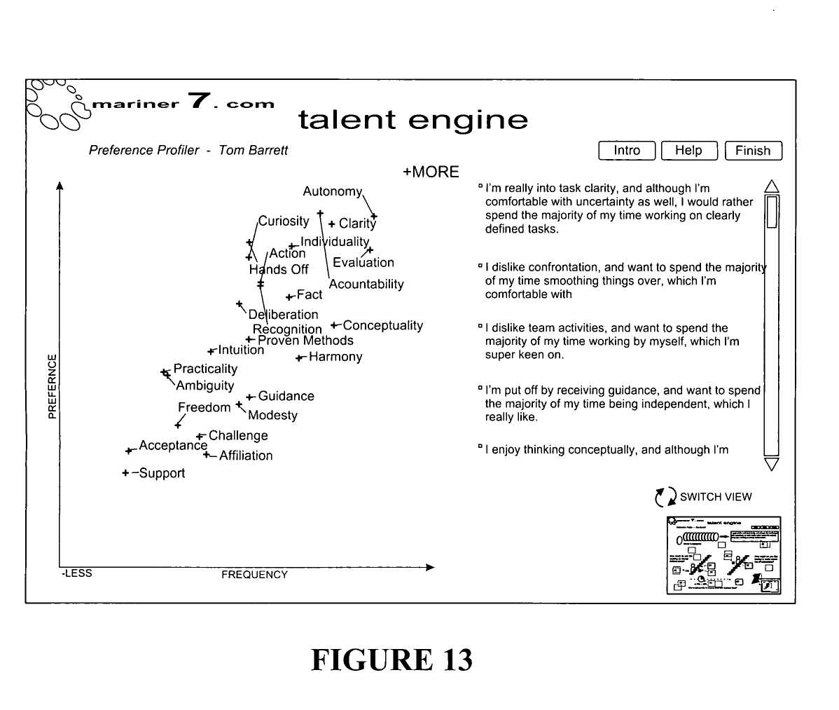

We might wish to ask a sample of individuals how important they think certain personal attributes are in their politicians. An example of a prior art questionnaire form to rate preferences for attributes might look like that in FIG. 14. The relation of each attribute to one another can then be displayed, mapping numbers onto the ordered response categories, in order to allow the data to be plotted graphically.

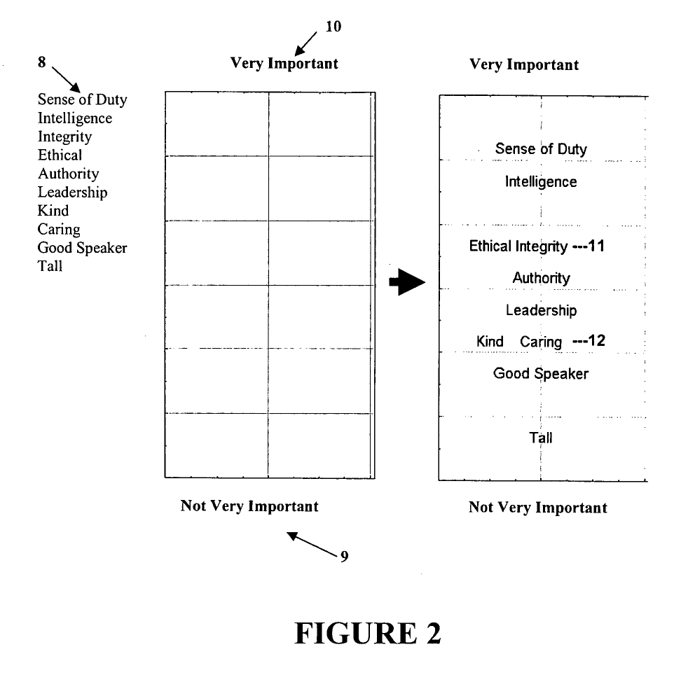

As an improvement, the present invention might be employed using a layout shown in FIG. 2. A range of attributes 8 can be placed in position between “Not very important” 9 and “Very important” 10 depending on their importance to the individual. One immediate and substantive advantage of this process over any others is that the user is able to see the cumulative build-up of their judgements instantaneously (permitting immediate adjustment perhaps of specific attribute positions). A second is that because no numbers are used, no implicit constraints are placed upon the user as to how they might wish to rate the attributes.

The present invention provides an instant graphical representation of the judgements, without the need to first acquire ratings, then order and present them as above in a 1 dimensional space. Note for example, the two “tied” ratings for “Ethical and Integrity” 11, and “Kind and Caring” 12. Further note, no numbers are required merely the polarity of the dimension at its extremes. Of course, a quantitative scale maybe placed on the vertical dimension such that the attribute coordinates can be extracted for further use or comparison between cases.

A Two Dimensional Example

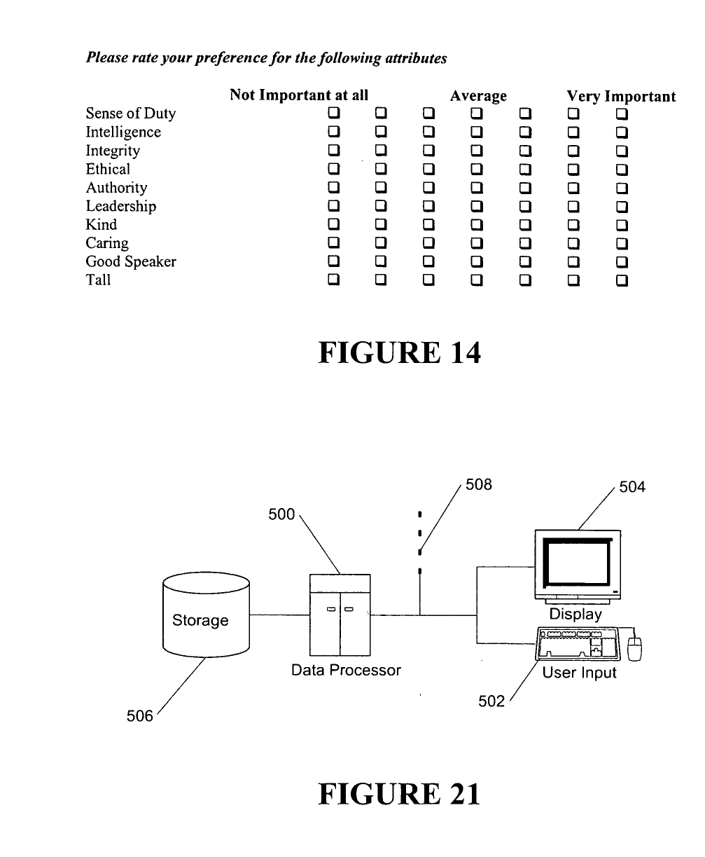

A further example uses an assessment of people's perceptions of car brands, judged in terms of their Performance and Maintenance Costs. An example questionnaire is given in FIG. 15.

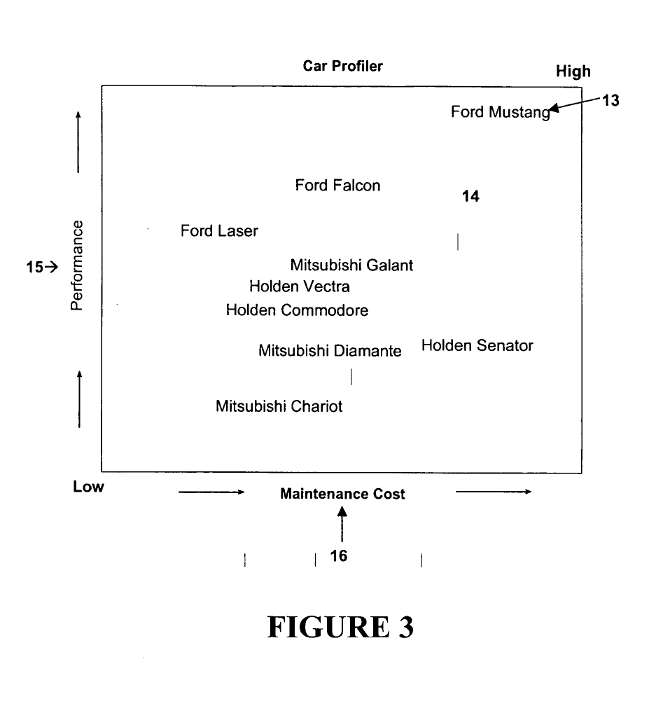

In the same situation the present invention might employ a layout as shown in FIG. 3. The individual simply places (using the computer mouse to pick up and place items into the “stimulus space”) the cars 13 into the space 14 according to their own judgement. The relationship between cars within the two dimensional framework is clear to see and interpret. Instead of having to plot the questionnaire data, and have individuals rate separately on each axis, the individual simply places each car within he stimulus space, relative to two clearly labelled axes of “Performance” 15 and “Maintenance” 16. Again, note the core innovation of the cumulative build-up of a rater's judgements being immediately accessible to the rater as they complete the task. The capacity to make immediate and subtle adjustments in their rating responses in the response area is a unique feature of the present invention.

A Three Dimensional Example

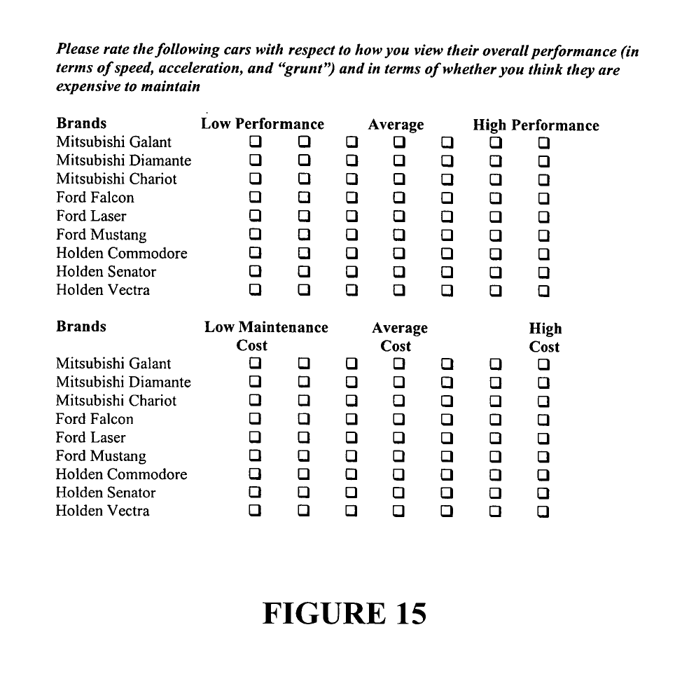

If we slightly modified the example above, using now 3 dimensions within which an individual could place cars, using say the dimensions of “Speed”, “Looks”, and “Maintenance”, a prior art questionnaire format might be as shown in FIG. 16.

This prior art example necessarily constrained the respondent to rate responses into a small integer range, and further, they have no simple means to make ratings of each car relative to previous ratings (that is, they cannot easily visualize each new car rating relative to previous car ratings, except by recourse to the numbered ratings).

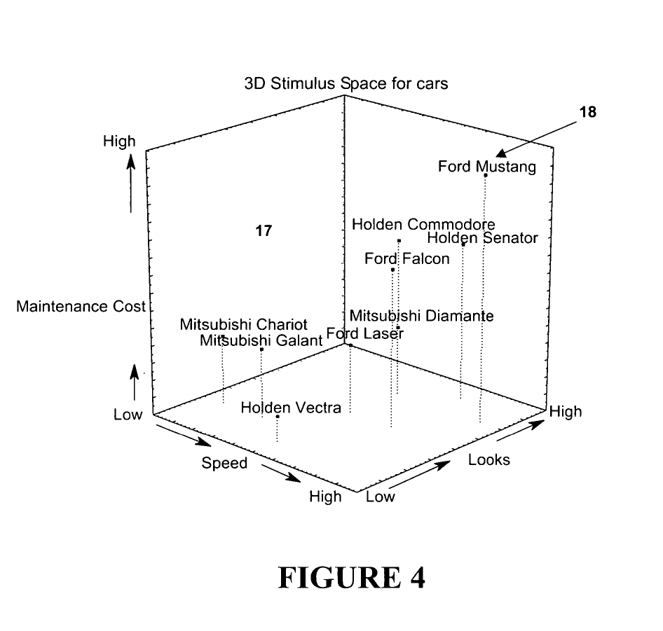

In contrast, the present invention might provide a 3 D sphere or cube 17, into which an individual would simply pick up and position each car 18, as shown in FIGS. 4 to 6.

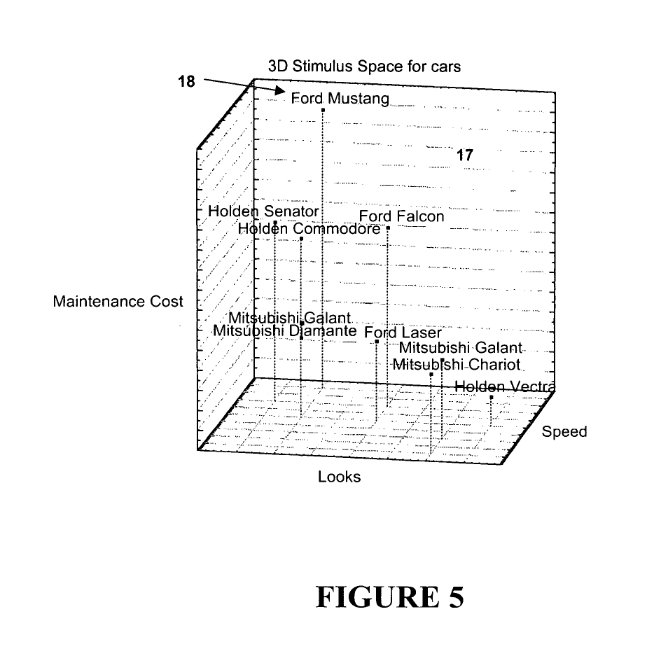

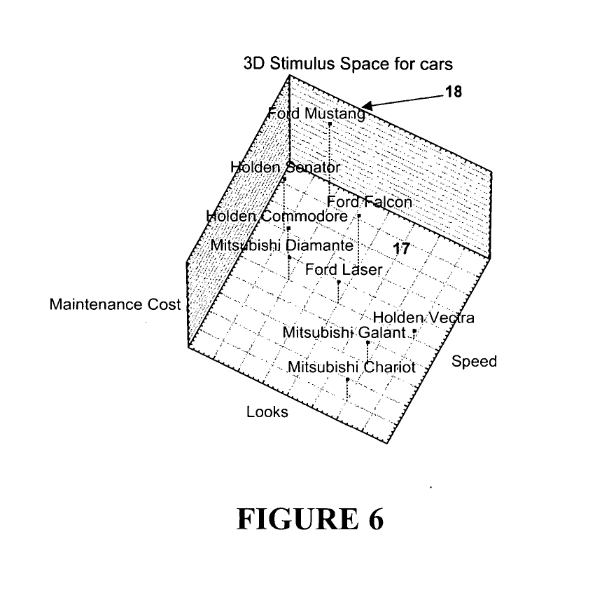

Working in a 3D environment would require the respondent be able to manipulate the graphical area so that different views would be accessible as it is extremely difficult to work in three dimensions whilst maintaining the correct perspective view. For example, dynamic rotations of the area might result in the view in FIG. 5 or FIG. 6 any of which might help the respondent position the cars.

It is possible that a sphere might be better as a stimulus space for 3D assessment rather than a cube but, this is merely an example of how the present invention can be applied in three dimensions.

The Quantitative Information That can be Extracted

The quantitative information available from a stimulus space is concerned specifically with the location of the objects/words within that space. Each object maybe described in terms of its location on each axis, given each axis is described by an ordered unit scale.

The scale units may be

linear-additive, as with a conventional 0 to 100 equal-interval unit scale or,

may be linear-additive after transformation from an a priori nonlinear scaling (using say logarithm or reciprocal scaling) or,

may be intrinsically non-linear as with say exponential, Markov Rule, or Cellular Automata step-functions or,

may be considered to be a unitless ordered scale, where positioning of attributes is via ordinal rank relations only (i.e. if an item is positioned higher than another on such a scale, it is assigned a rank score that reflects its relative position with respect to the lower item. No information is available as to any units of measurement that might have been used to express the ratio of one attribute's position with respect to a standard position unit, to another

So, irrespective of the number of axes used to bound or define a region, as long as each possesses a scale of measurement or a rank-order relation axis, then an object can be uniquely identified within the space by using either its absolute position or rank order relative to other attributes on a single variable axis. These axis positions or rank orders are in essence the object identifying coordinates or positional rank, and can be manipulated as such (for example, for comparative matching, averaging, or ranking purposes between many respondents).

The placing of objects into a stimulus space may be further augmented beyond the standard examples above. For example, the objects to be placed into a stimulus space may themselves carry with them rules that determine how they behave in that space in relation to the proximity of other objects and/or axes.

The present invention can be applied to any task where a judgement about an attribute or object is required to be made by an individual. Some features of several of the preferred embodiments of the present invention are:

1. Attributes or objects for rating are moved into or onto a response area, defined in one, two, or three dimensions.

2. A user is not required to make any kind of numerical rating or judgement of an attribute or object, although one can be made if considered desirable, acceptable, or necessary.

3. The variable axes or response scales remain static throughout the assessment. It is the attributes or objects to be rated that are the dynamic features of the process.

4. The user can see all previous “rating” activity prior to any new rating of an attribute and object. This is a feature of the present invention—simultaneous and cumulative, visually-explicit, direct development of an entire set of ratings/judgements. This is unique to the present invention.

5. The “historical” rating activity actually populates the current rating response area, such that a new rating response (after the initial one) is always elicited within the cumulative nomological (meaning-laden) framework of previously rated/positioned attributes/objects.

6. When using bipolar attributes to be rated, no fixed relationship between the assessment on one polar descriptor and the other need be imposed. That is, the conventional inverse linear relationship imposed by nearly all psychological trait, attitude, and preference questionnaire scales is rendered entirely optional with the use of the present invention (the one exception to this is within attitude measurement where the quantitative analytical technique of cumulative unfolding can demonstrate that an attitude may not be symmetric and equal-interval “inverse” around a reference value on the scale).

A Psychological Profiling of Work Preferences and Frequencies Example

The present invention might, for example, be employed to acquire measurement of an individual's work preferences and the frequency throughout a working day that the individual would like to be engaged in them.

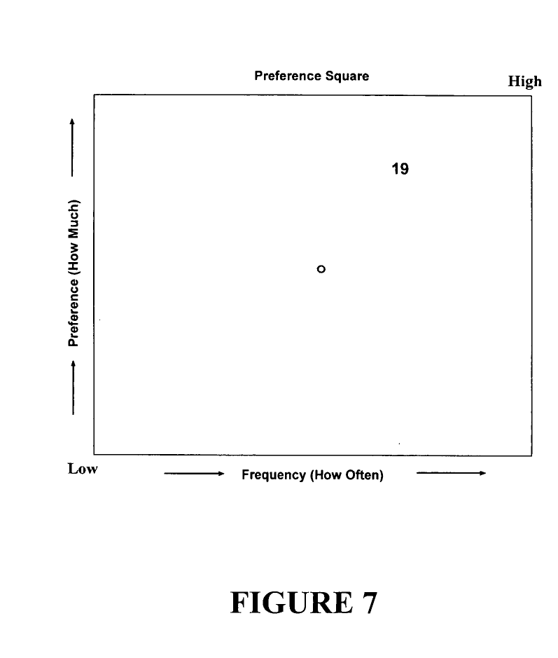

In FIG. 7, we have a 2 dimensional response area 19 into which we will ask an individual to place attributes. Then, the individual is presented with a list of twelve attributes that are required to be place within the 2D space one at a time. The individual is asked to place the attributes into the space according to how much they like each to experience each attribute within their working environment, and the amount of time they like to experience it.

Twelve appropriate attributes are given in capitals below. Alongside in brackets are their complementary attributes. These complements are not immediately available to the individual.

| | |
|---|---|
| CLARITY | (Ambiguity) |
| CHALLENGE | (Harmony) |
| AFFILIATION | (Individual) |
| AUTONOMY | (Support) |
| CONCEPTUAL | (Practical) |
| INTUITIVE | (Fact based) |
| EVALUATIVE | (Accepting) |
| CURIOSITY | (Proven Methods) |
| INFLUENCE | (Observer) |
| ACTION ORIENTED | (Information-oriented) |
| RECOGNITION | (Self Effacing) |
| ACCOUNTABILITY | (Carefree) |

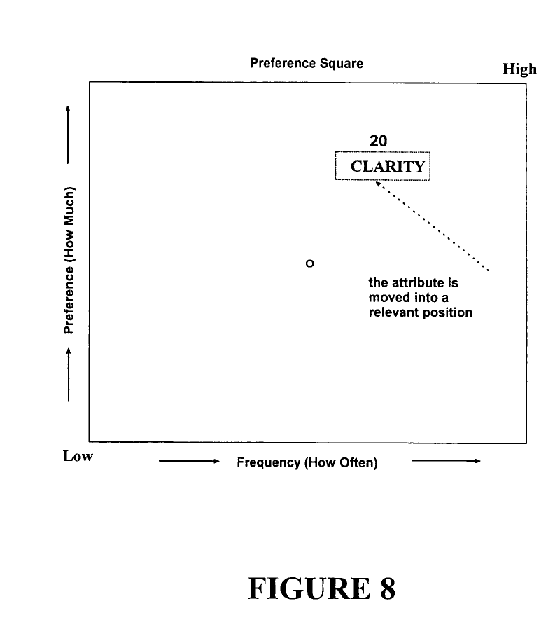

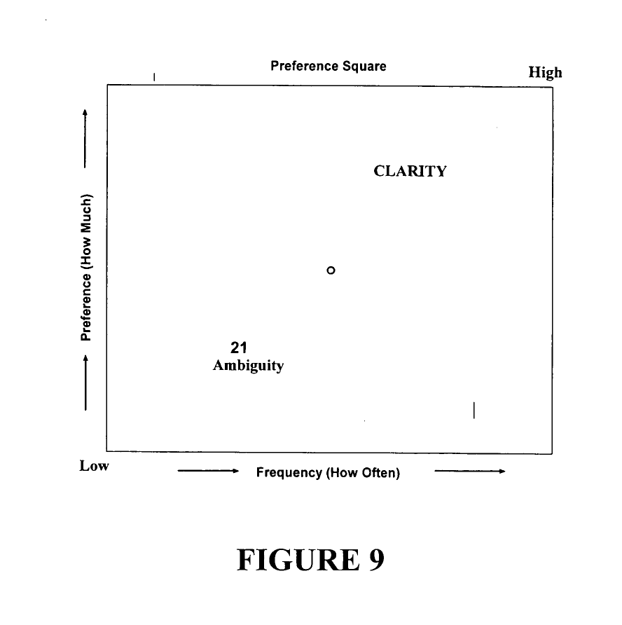

The individual “picks up” the first attribute 20 with the mouse (all others are “optioned out”), as shown in FIG. 8, and moves it to a region within the 2D “grid” 19 and releases the mouse button. In doing so, as seen in FIG. 9 the opposite 21 of the attribute 20 now appears at the inverse X, Y coordinate position in the Grid 19. This is the first rule constraint on the attribute.

The individual now has the capability of selecting and moving either of the attributes on display. However, whilst movement of either attribute is unrestricted in the Y plane 22, the second attribute rule constrains movement in the X plane 23. Specifically, the attributes may be moved and place quite independently in the Y plane 22, but, the attributes are linked directly and inversely in the X plane 23 such that any movement of either attribute causes an equal and opposite movement of the other half of the attribute pair. This X plane rule is relevant for this example but it will be appreciated that various similar rules may be appropriate in other examples.

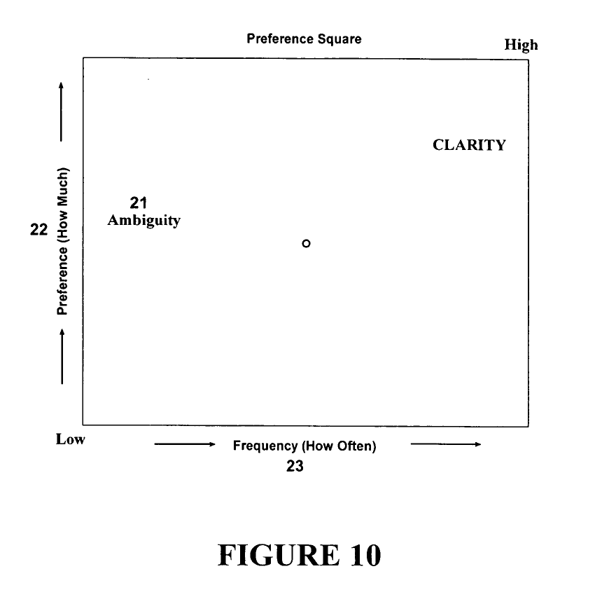

FIG. 10 shows permissible attribute 21 re positioning in the Y plane 22, and the effect of an individual indicating that they want clarity as much as possible in a working day. What this indicates is that the individual can tolerate more ambiguity in their job than originally indicated by the default inverse placement, but that they really like clarity most of the time and only want to experience ambiguity in small doses. Again, it is important to note that the rules applied to each axis are optional.

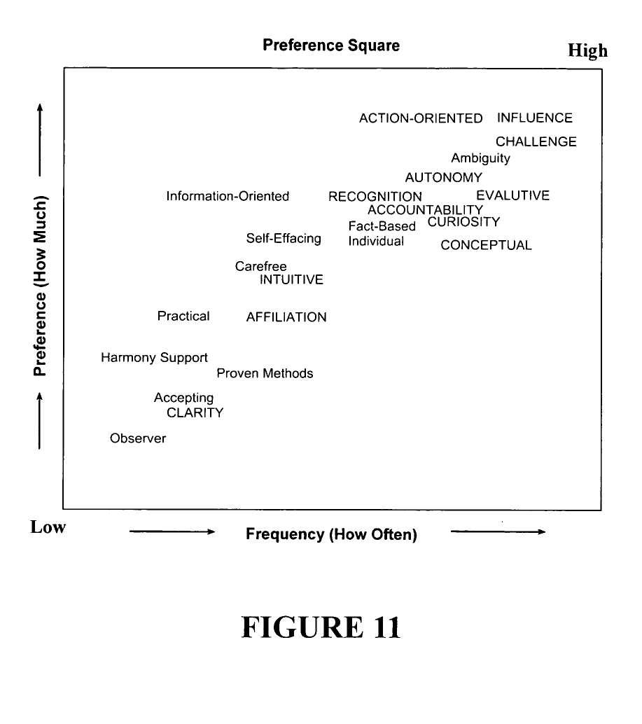

Now the individual continues to place each of the eleven remaining constructs into the response area, in the manner described previously. A complete response grid might look like that shown in FIG. 11, which shows an individual's work related values and preferences without having asked a single question. Further, as the number of constructs/attributes placed into the response area has increased, the individual has been forced to take into account the relative position of each in relation to each other. This is similar to using a forced choice questionnaire format, in that not only does the individual have to place each pair of attributes according to their preference, but also has to bear in mind the previous placements (in order to best represent the total picture of their work preferences and values).

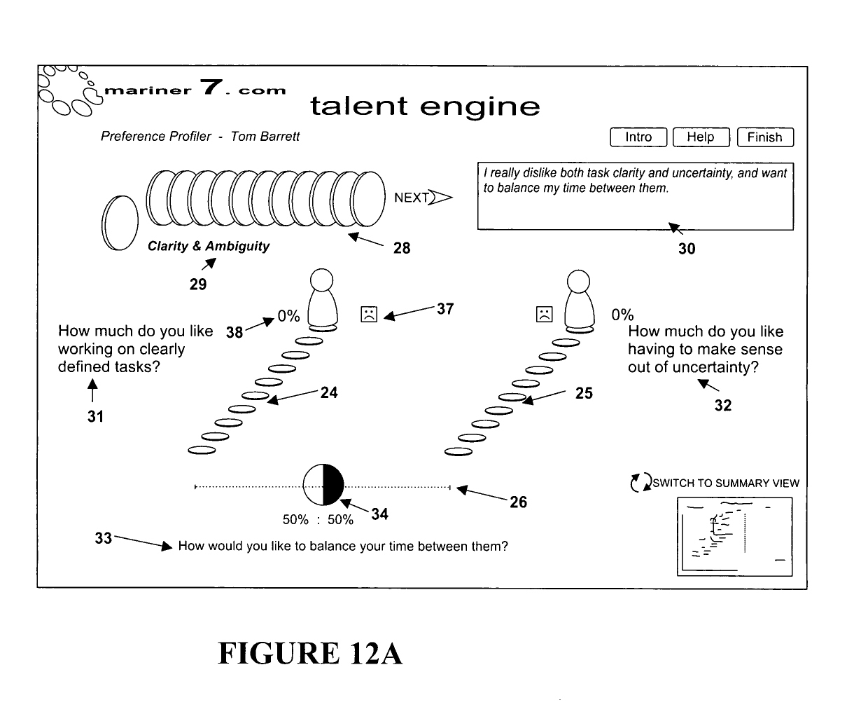

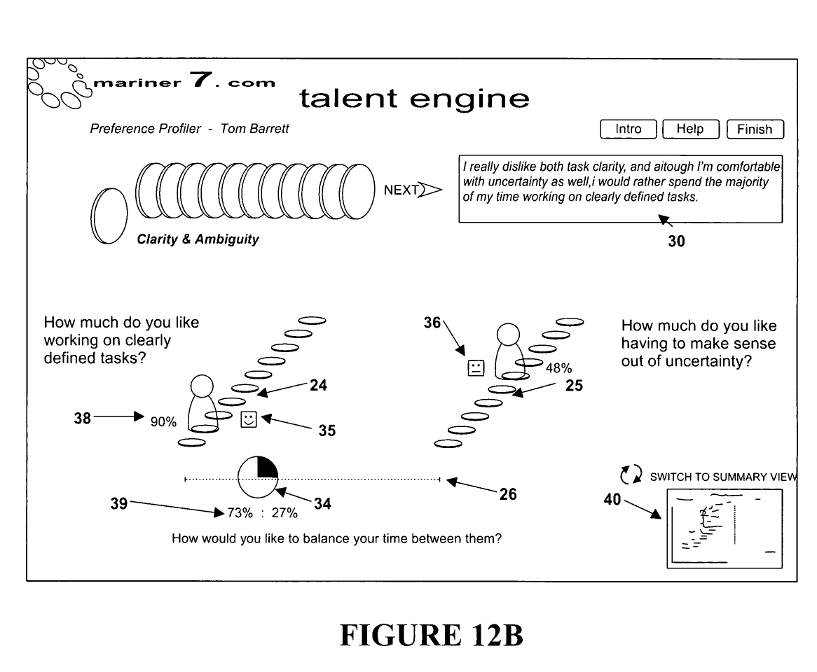

In a further embodiment of the present invention, seen in FIGS. 12A & 12B, the present invention is shown applied show applied to the example above with an alterative interface. The user provides preference ratings using two sliders 24,25 (one for each pair of the complementary attributes), and a frequency response slider 26. As the user completes each attribute pair in turn, they can switch at any point to the alternate view (shown in FIG. 13), and make direct adjustments in the stimulus space 27.

The interface initially displays a set of discs 28 in the top left hand corner or the screen shown in FIG. 12A. Each disc is associated with a pair of complementary words e.g. “Clarity & Ambiguity” 29. Next to the discs, on the right hand side of the screen, is a text box 30 that provides verbal statements describing or characterising the current positions of the three “sliders”. As shown in FIG. 12A the two “horizontal perspective” sliders 24,25 are initially set at 0%, with the horizontal frequency response slider 26 set at 50:50%.

Associated with each of the three sliders is a text fragment that explains the meaning of each of the slider rating for that particular complementary word pair 31,32,33. Each slider also has a graphic depicting either like 35, ambivalence 36 or dislike 37. The frequency slider shows a pie graph 34 which depicts the percentage ratio.

The user moves the sliders to represent their preference for each of the two “pawn” slider attributes, and to indicate the relative frequency for doing each during a working day. In one embodiment this is achieved by the user using a mouse to “move” each of the pawns and clock on the frequency bar. In FIG. 12B we see the % amount 38 and face icon 35 change dynamically as the pawn moves over the range of the “Clarity” slider 24.

Similarly the pie graph 34 reflects the amount of time to be allocated between the two attributes relative to the % time 39.

The text in the “statement box” 30 in FIG. 12B displays a statement that reflects the current position of all three sliders. This is dynamically updated as each slider is moved.

The user would then select the next attribute pair from the discs 28, and proceed to make their responses as above.

At any time during this process, the user can select the alternate view and cumulatively updated text output area, shown in FIG. 13. This view is updated cumulatively. The view control 40 is located in the bottom right hand corner of the screen. If we look in detail at this view, we see on the left hand side the preference stimulus space 27, in which attributes have been positioned according to the “slider values” assigned by the user.

This shows “at a glance” the cumulative picture of a user's work preferences and frequencies in a 2 dimensional “space” bounded by the two axes of preference and frequency. Note however, that this is not a static display, but is actually “live” in that a user can now make adjustments in either dimension to the position of any attribute. By placing the mouse cursor on any of the “+” positional markers, the associated attribute pair names are highlighted for the user.

On the left hand side of the screen, the cumulative text descriptions 41 of the evolving preference map are listed. The scroll bars 42 at the side allow the user to see all statements as they are generated. At any point, the user is free to return to the single attribute pair rating screen by clicking on the view control box 43 at the lower right hand corner of the interface screen.

So, in this way, the user is able to dynamically create and modify their responses such that they can achieve the “picture of their preferences and frequencies” and view the results of their ratings interactively.

An Example from the Domain of Partner Compatibility Assessment

This example shows how the present invention might be used as part of the assessment process carried out by dating agencies. It is also an example of personality measurement using single-item attribute psychometrics. One of the assessments required is that of the personality of an individual looking for a partner. Further, it is usual to ask for what kind of personality their ideal partner may have. Conventionally, these kinds of assessment are made using two questionnaires, one for the individual who is searching for a partner, the other for their ideal partner.

However, instead of this rather lengthy procedure, it may be advantageous to use the present invention. Unlike the example above, here we use 1-Dimensional measurement, as what we are interested in is the direct assessment of personality attributes, via self-report rating.

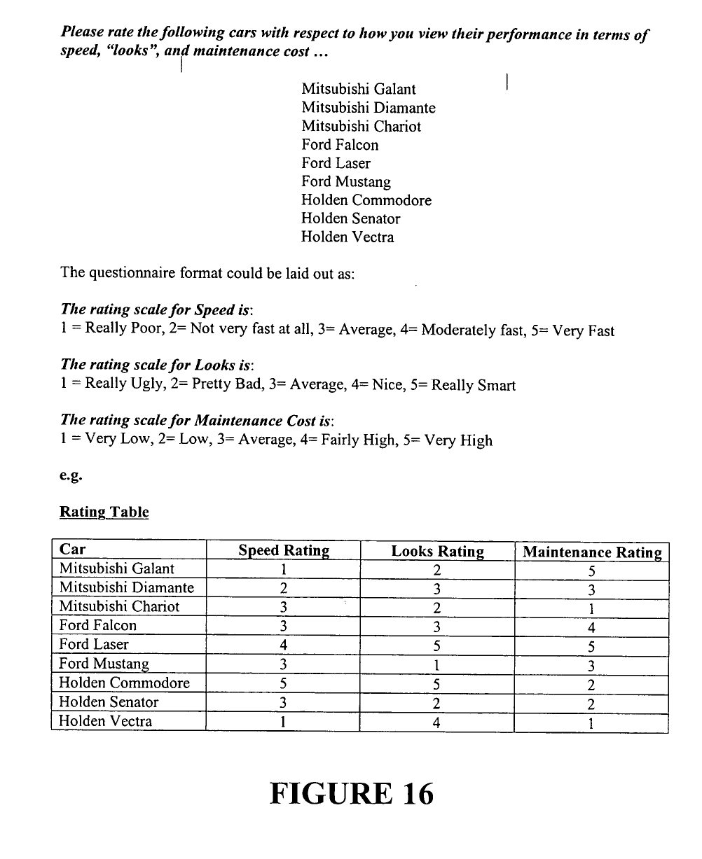

An example assessment “screen” could look like that in FIG. 17, where we ask the individual to choose the attributes and position them on two scales. One represents the scale entitled “Me” 44 which spans two extremes, “Most Like [Me]” 45 and “Least Like [Me]” 46, the other entitled “My Ideal Partner” 47 also spans the two extremes “Most Like [My Ideal Partner]” 48 and “Least Like [My Ideal Partner]” 49.

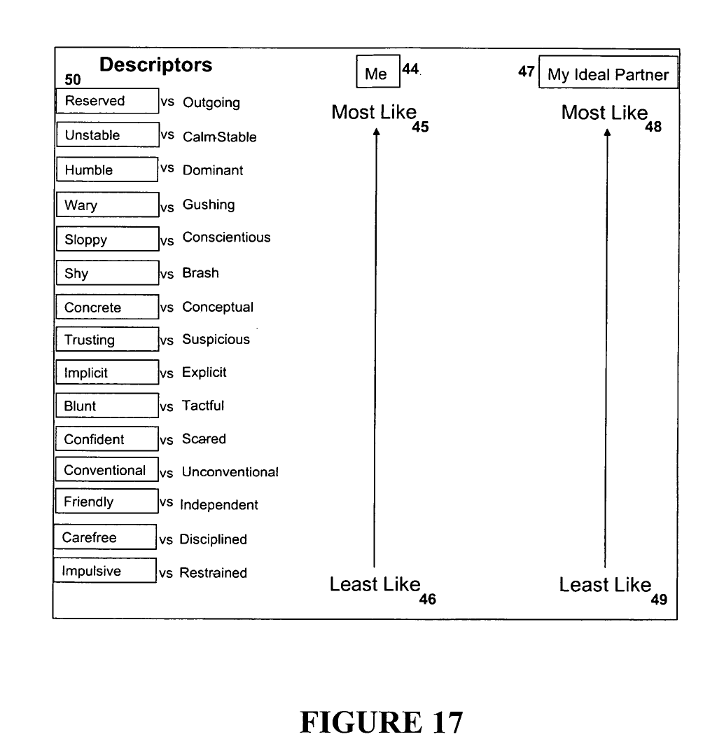

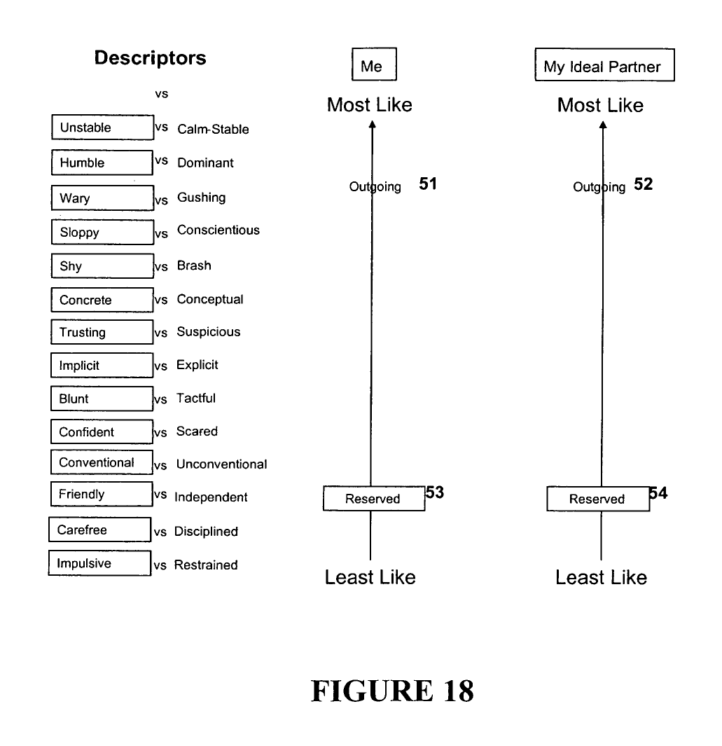

The personality attributes 50 are placed in a convenient area on-screen. The individual is now required to select one and place it on the appropriate rating scale, reflecting their judgement. As they do this, the “opposite or complement of the pair” is placed automatically onto the line at the complementary position (the same distance as the grey-box descriptor is from the nearest pole). For example, FIG. 18 shows the initial positions after moving just the first personality/attribute descriptor. Note that initially, both the “Me” 51,52 and “My Ideal Partner” 53, 54 responses are equivalent. The individual can then make adjustments directly on each slider—for each attribute—such that they may make their final choice as shown in FIG. 19.

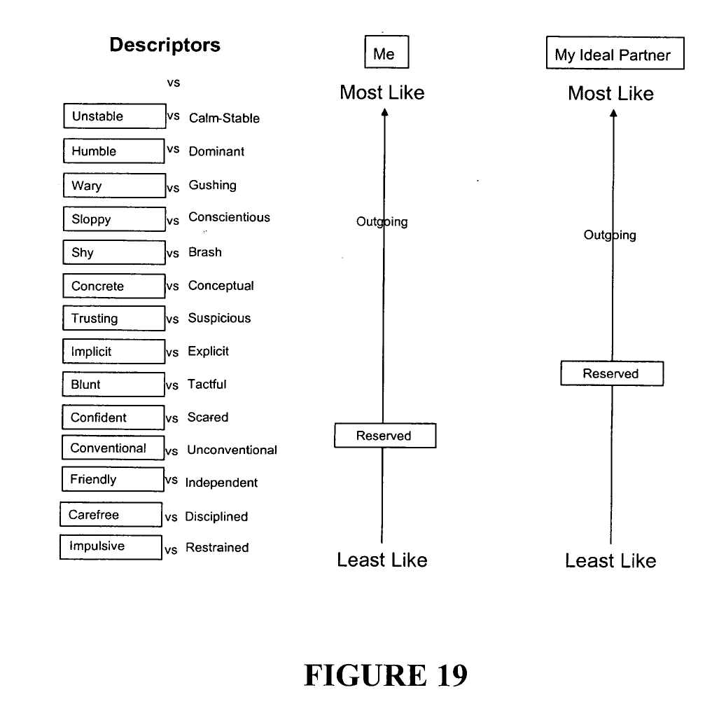

Completing a few more descriptors might look like the display presented in FIG. 20.

Note that with the personality assessment example above, the complement or opposite of each pair of descriptors is not required to be an absolute opposite (as with all other personality tests on the market today). We allow for the fact that a person may feel they are Outgoing, but not necessarily Reserved to the same degree. In fact, the present invention places fewer constraints on an individual's responses than any other existing form of assessment—barring psychodynamic projective tests and free-response interview response. But, we codify these responses on a measurement scale or ordered rank scale —which immediately makes them amenable to quantitative data analysis using either parametric or non-parametric techniques.

As can be seen from this specific embodiment of the present invention, another unique feature is introduced by its application. That is, when using conventional bipolar attributes for rating by an individual, the present invention does not constrain the rating of either pole. This is unique within the domain of personality assessment that uses constituent trait items to assess a level of “trait” personality within an individual. For example, with a trait scale of “Extraversion”, whose opposite pole is “Introversion”, an individual's score will determine not only their level of the trait “Extraversion”, but also by direct subtraction, their level of “Introversion”. i.e. if I score 15 out 20 on Extraversion, my score in Introversion will be 20−15=5. However, the present invention relaxes this somewhat artificial constraint, allowing the individual to express the rating of their own personality without the need to maintain a perfectly linear “difference” relationship between the two attribute poles. Whilst this may cause problems with personality trait measurement construed within conventional psychometric-test practice, it causes no such problem for single attribute psychometrics. The present invention thus permits a more unconstrained assessment of personality attributes, one that is likely to be more accurate and reflective of an individual's judgements.

1. A system for interrogating at least one subject comprising:
at least one graphical interface configured to display the positions of a plurality of attributes relative to at least one or more coordinate axes or rankings depending on a control signal,
at least one input configured to receive ranking or positioning information for each of said plurality of attributes, and
at least one controller or processor configured to receive and/or store the relative ranking or positioning information for each attribute from said input means, and adapted to supply said control signal to said graphical interface means.

2. A system for interrogating at least one subject as claimed in claim 1 wherein said control means adapted to receive and/or store optional reranking or repositioning of each attribute from said input means.

3. A system for interrogating at least one subject as claimed in claims 1 or 2 wherein said control means adapted to constrain and/or effect positioning and/or ranking of any attribute, depending on the positioning and/or ranking of any previous attribute.

4. A method of interrogating at least one subject, comprising the steps of:
a) displaying at least one response area for a plurality of attributes relative to at least one axis defining the area;
b) receiving input from said subject representative of an axis coordinate(s) and/or at least one relative ranking within said response area for a first attribute;
c) storing said input
d) displaying at least said first attribute positioned within said response area according to at least said input and
e) receiving input from said subject representative of an axis-coordinate(s) and/or at least one relative ranking within said response area for at least one further attribute.

5. A method as claimed in claim 4 further comprising the step:
f) converting input from said subject into at least one electronic signal(s) representative of an axis-coordinate(s) and/or at least one relative ranking within said response area for a plurality of further attributes.

6. A method as claimed in claim 5 further comprising the steps:
g) displaying on said graphical display means each of said plurality of attributes positioned within said response area according to at least said stored electronic signal(s), and
h) converting input from said subject into at least one electronic signal(s) representative of reranking or repositioning each of said plurality of attributes.

7. A method as claimed in any one of claims 4 to 6 wherein electronic signal(s) representative of axis-coordinate(s) and/or at least one relative ranking of any of said plurality of attributes, may be constrained by and/or may in turn effect, said stored electronic signal(s) representative of axis-coordinate(s) and/or at least one relative ranking of any other of said plurality of attributes.

8. A method as claimed in claims 4 to 7 further comprising an initial step of displaying on said graphical display means at least one linear response scale, each said scale for an individual attribute relative to a single variable, axis-coordinate and/or relative ranking.

9. A method of psychometric testing of at least one subject, comprising the steps of:
A) displaying at least one response area for a plurality of characteristics relative to at least one rating-axis defining the area;
B) receiving input from said subject representative of a rating(s) and/or at least one relative ranking within said response area for a first characteristic;
C) storing said input
D) displaying at least said first characteristic positioned within said response area according to at least said input and
E) receiving input from said subject representative of a rating(s) and/or at least one relative ranking within said response area for at least one further characteristic.

10. A method as claimed in claim 9 further comprising the step:
F) converting input from said subject into at least one electronic signal(s) representative of a rating(s) and/or at least one relative ranking within said response area for a plurality of further characteristics.

11. A method as claimed in claim 10 further comprising the steps:
G) displaying on said graphical display means each of said plurality of characteristics positioned within said response area according to at least said stored electronic signal(s), and
H) converting input from said subject into at least one electronic signal(s) representative of reranking or rerating each of said plurality of characteristics.

12. A method as claimed in any one of claims 9 to 11 wherein electronic signal(s) representative of a rating(s) and/or at least one relative ranking of any of said plurality of characteristics, may be constrained by and/or may in turn effect, said stored electronic signal(s) representative of a rating(s) and/or at least one relative ranking of any other of said plurality of characteristics.

13. A method as claimed in claims 9 to 12 further comprising an initial step of displaying on said graphical display means at least one linear response scale, each said scale for an individual characteristic relative to a single variable, rating and/or relative ranking.

14. A method of a market survey of at least one subject, comprising the steps of:
i) displaying at least one response area for a plurality of attributes relative to at least one axis defining the area;
ii) receiving input from said subject representative of an axis coordinate(s) and/or at least one relative ranking within said response area for a first attribute;
iii) storing said input
iv) displaying at least said first attribute positioned within said response area according to at least said input and
v) receiving input from said subject representative of an axis-coordinate(s) and/or at least one relative ranking within said response area for at least one further attribute.

15. A method as claimed in claim 14 further comprising the step:
vi) converting input from said subject into at least one electronic signal(s) representative of an axis-coordinate(s) and/or at least one relative ranking within said response area for a plurality of further attributes.

16. A method as claimed in claim 15 further comprising the steps:
vii) displaying on said graphical display means each of said plurality of attributes positioned within said response area according to at least said stored electronic signal(s), and
viii) converting input from said subject into at least one electronic signal(s) representative of reranking or repositioning each of said plurality of attributes.

17. A method as claimed in any one of claims 14 to 16 wherein electronic signal(s) representative of axis-coordinate(s) and/or at least one relative ranking of any of said plurality of attributes, may be constrained by and/or may in turn effect, said stored electronic signal(s) representative of axis-coordinate(s) and/or at least one relative ranking of any other of said plurality of attributes.

18. A method as claimed in claims 14 to 17 further comprising an initial step of displaying on said graphical display means at least one linear response scale, each said scale for an individual attribute relative to a single variable, axis-coordinate and/or relative ranking.

19. A method of interrogating a first subject for the purpose of matching to a second subject from a plurality of subjects comprising the steps:
I) displaying at least one response area for a plurality of characteristics relative to at least one axis defining the area;
II) receiving input from said subject representative of an axis coordinate(s) and/or at least one relative ranking within said response area for at least one representative characteristic of said first subject;
III) receiving input from said subject adapted to represent axis representative of an axis coordinate(s) and/or at least one relative ranking within said response area for at least one desired characteristic in said second subject
IV) storing a said input and
V) displaying at least said at least one representative characteristic and at least one desired characteristic positioned within said response area according to at least said input

20. A method of interrogating as claimed in claim 19 further comprising the step:
VI) converting input from said subject on an interface means adapted to represent axis-coordinate(s) and/or at least one relative ranking into at least one electronic signal(s) representative of an axis-coordinate(s) and/or at least one relative ranking within said response area for a plurality of representative characteristics of said first subject and a plurality of desired characteristics in said second subject.

21. A method of interrogating at least one subject substantially as described as any of the embodiments herein.

22. A system for interrogating a subject substantially as described as any of the embodiments herein with reference to and as illustrated by any of the accompanying drawings.

23. A method of psychometric testing of at least one subject substantially as described as any of the embodiment herein.

24. A method of market survey of at least one subject substantially as described as any of the embodiment herein.

25. A method of interrogating a first subject for the purposes of matching to a second subject from a plurality of subjects substantially as described as any of the embodiments herein.

26. A method of interrogating at least one subject comprising the steps of: displaying a response area for at least three attributes relative to at least one axis;
receiving input from said subject representative of a first coordinate or ranking relating to a first attribute;
receiving input from said subject representative of a second coordinate or ranking relating to a second attribute;
receiving input from said subject representative of a third coordinate or ranking relating said first attribute to said second attribute;
storing said input;
displaying said first, second and third attributes according to said input.

27. A method of interrogating at least one subject as claimed in claim 26 further comprising the steps of providing a natural language summary, relevance or analysis of said first second and third coordinate or rankings.

28. A method of interrogating at least one subject as claimed in claim 27 wherein said first and second attributes are substantially polar opposites.

29. A method of interrogating at least one subject as claimed in claim 28 wherein said third coordinate or ranking relates to a time preference between said first and second attributes.

30. A system for interrogating at least one subject comprising
at least one interface configured to receive a first coordinate of ranking relating to a first attribute, receive a second coordinate or ranking relating to a second attribute and receive a third coordinate or ranking relating said first attribute to said second attribute; and
at least one controller or processor configured to receiving said first, second and third co-ordinates or rankings and provide an output signal depending thereon; and
at least one graphical display configured to present at least one image depending on said output signal.

31. A system for interrogating at least one subject as claimed in claim 30 further wherein said output signal includes a natural language summary, relevance or analysis of said first second and third coordinate or rankings.

32. A system for interrogating at least one subject as claimed in claim 31 wherein said interface configured such that first and second attributes are substantially polar opposites.

33. A system for interrogating at least one subject as claimed in claim 32 wherein said interface configured such that said third coordinate or ranking relates to a time preference between said first and second attributes.
